(19) United States
(12) Patent Application Publication
(10) Pub. No.: US 2007/0177952 A1
(43) Pub. Date: Aug. 2, 2007

(54) Hole locating device and mechanism

(75) Inventor: John E. McCracken, Glen Mills, PA (US)

Correspondence Address: WILDMAN HARROLD ALLEN & DIXON LLP;AND THE BOEING COMPANY, 225 W. WACKER DR., CHICAGO, IL, 60606, US

(73) Assignee: The Boeing Company

(21) Appl. No.: 11/344,997

(22) Filed: Jan. 31, 2006

(51) Int. Cl. B23B 47/28

(52) U.S. Cl. 408/115 B

(57) ABSTRACT

The invention relates to hole locating devices and to methods for their use. An apparatus under the invention may be used to aid in locating and/or drilling holes in a composite. The apparatus may be used to locate holes to be drilled in a post-cure composite which may be formed on a surface of a tool during a curing process. The apparatus may be utilized to locate and/or drill holes in parts of an airplane or in non-airplane applications. Such an apparatus may include a body defining a bore and a cap. A first end of the body may be adapted to be secured to an interior surface of a hole defined in a tool for forming a composite. The cap may be adapted to be hermetically sealed to a second end of the body.

### BACKGROUND OF THE INVENTION

Tools are often used to manufacture composites. The tools typically comprise a first surface in a pre-determined shape. During heating of the composite, the first surface of the tool often abuts against the composite in order to dictate the shape of the manufactured composite. After the curing process, it is often necessary to locate and/or drill holes in one or more locations of the manufactured composite. However, many of the existing apparatus, and methods for their use, which are designed to aid in locating and/or drilling holes in manufactured composites suffer from one or more problems which may make hole location and/or drilling more difficult. These may include one or more of the following problems including cost, accuracy, efficiency, complexity and number of parts of the required equipment, repeatability, time of manufacture, and/or breakdown in equipment. An apparatus and method for its use is needed which may solve one or more problems in locating and/or drilling holes in a composite part.

### SUMMARY OF THE INVENTION

In one aspect of the invention, an apparatus to aide in drilling holes in a composite comprises a body defining a bore and a cap. The body includes first and second ends. The first end of the body is adapted to be secured to an interior surface of a hole defined in a tool for forming the composite. The cap is adapted to be hermetically sealed to the second end of the body.

In another aspect of the invention, an apparatus to aide in drilling holes in a composite comprises a body defining a bore, and a tool defining at least one hole. The body comprises first and second ends, while the tool comprises a first surface which is adapted to abut against the composite, a second opposing surface, and an interior surface of the at least one hole. The first end of the body is adapted to be inserted into and secured within the interior surface of the at least one hole while another portion of the body is disposed over the second opposing surface of the tool.

In a further aspect of the invention, a method is disclosed for preparing a composite to have one or more holes drilled in the composite. A body is provided. The body defines a bore and comprises first and second ends. A tool is provided. The tool defines at least one hole, and comprises a first surface adapted to define a shape of the composite, a second opposing surface, and an interior surface of the at least one hole. The first end of the body is inserted into the at least one hole while at least a portion of the body is disposed over the second opposing surface of the tool.

These and other features, aspects and advantages of the invention will become better understood with reference to the following drawings, description and claims.

### BRIEF DESCRIPTION OF THE DRAWINGS

FIG. 1 is a perspective view of one embodiment of an assembled apparatus under the invention;

FIG. 2 is a perspective view of the body of FIG. 1 with the cap disassembled;

FIG. 3 is a perspective view of the cap of FIG. 1 with the body disassembled;

FIG. 4 depicts a partial perspective view of the apparatus of FIG. 1 attached to a tool;

FIG. 5 depicts a partial cut-away view of FIG. 4 showing the cap partially cut-away to show the attachment of the cap to the body;

FIG. 6 depicts a partial cut-away view along line 6-6 in FIG. 4 to show a partial cross-sectional view through the tool and apparatus; and

FIG. 7 depicts one embodiment of a method under the invention for preparing a composite to have one or more holes drilled in the composite.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

Generally, an apparatus under the present invention may be used to aid in locating and/or drilling holes in a composite. Such an apparatus may be used to locate holes to be drilled in a post-cure composite which may be formed on a surface of a tool during a curing process. The apparatus may be utilized to locate and/or drill holes in parts of an airplane or in non-airplane applications.

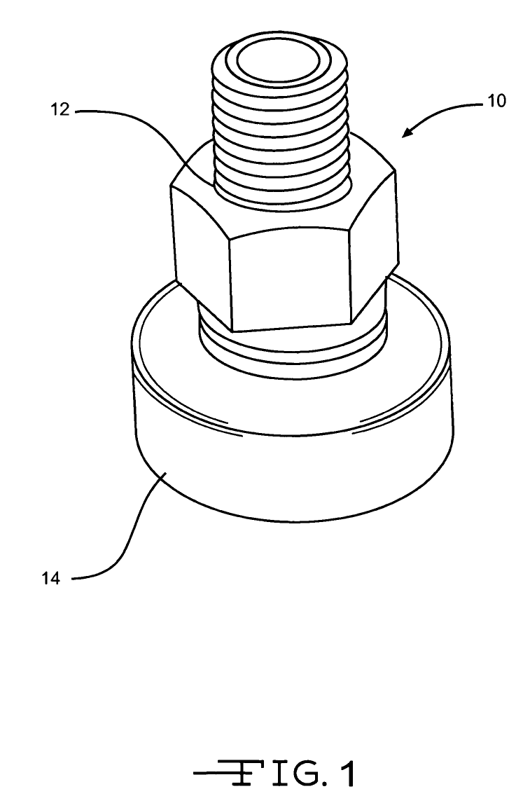

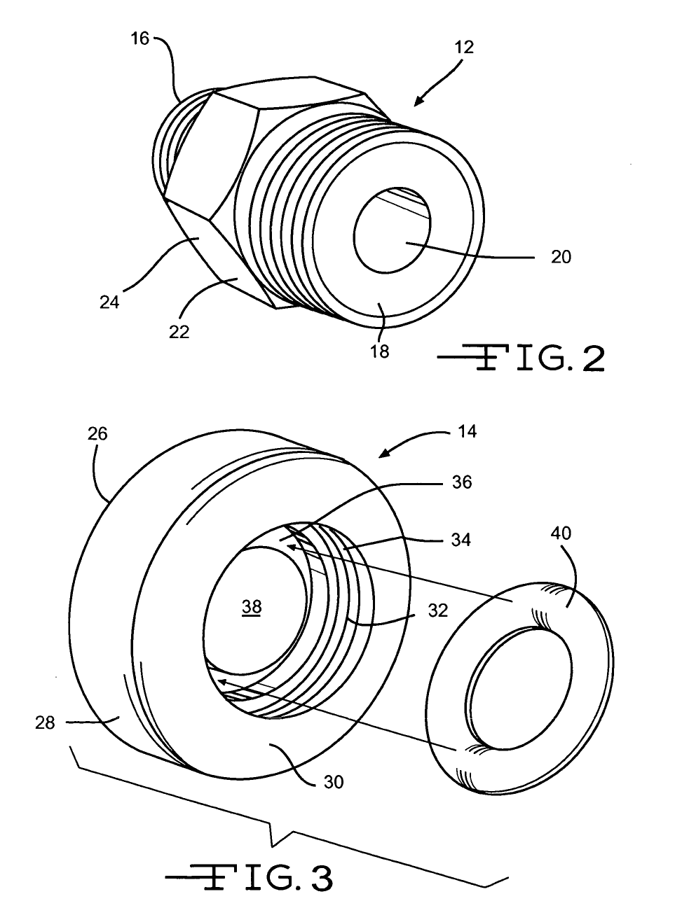

FIG. 1 depicts a perspective view of one embodiment of an assembled apparatus 10 under the invention. As shown, the apparatus 10 may comprise a body 12 and a cap 14. FIG. 2 depicts a perspective view of the body 12 with the cap 14 disassembled from the body 12. The body 12 may comprise first and second ends 16 and 18. The body 12 may be made of steel, but in other embodiments may be made of any material known in the art. Preferably, the body 12 has substantially the same coefficient of thermal expansion as the tool it is adapted to be used with. A bore 20 may extend through a cross-section of the body 12 from the first end 16 through the second end 18. The body 12 and/or bore 20 may be annular or, in other embodiments, may comprise varying shapes, sizes, configurations, and orientations. The first end 16 of the body 12 may be adapted to be secured to an interior surface of a hole of a tool, and the second end 18 of the body may be adapted to be hermetically secured to a cap. For instance, the first and/or second ends 16 and 18 of the body 12 may be threaded. A ledge 22 of the body 12 may be adapted to be disposed over and/or abutted against an opposing surface of a tool, such as the back non-critical surface of a molding tool. The ledge 22 may be substantially perpendicular to one or more of the first and second ends 16 and 18 of the body 12. The ledge 22 may comprise a hexagonal surface extending perpendicularly around a periphery of a mid-section 24 of the body 12. In other embodiments, varying configured surfaces of the body 12 may be adapted to abut against an opposing surface of a tool.

FIG. 3 depicts a perspective view of the cap 14 with the body 12 disassembled from the cap 14. The cap 14 may comprise a top closed-off outer surface 26, a substantially annular outer surface 28 extending substantially perpendicularly from the top closed-off outer surface 26, and a bottom outer surface 30 defined by a hole 32. An interior surface 34 within the hole 32 of the cap 14 may be threaded, may extend around the interior circumference of the cap 14, and may be adapted to threadedly attach the cap 14 to the second end 18 of the body 12. A groove 36 may extend around a top inner surface 38 of the cap 14. An O-ring seal 40 may be disposed within the groove 36 and may extend around the top inner surface 38 of the cap 14. The cap 14 may be adapted to be hermetically sealed to the second end 18 of the body 12. The cap 14 may be made of steel, but in other embodiments may be made of any material known in the art. In still other embodiments, the cap 14 may comprise varying shapes, sizes, configurations, and orientations.

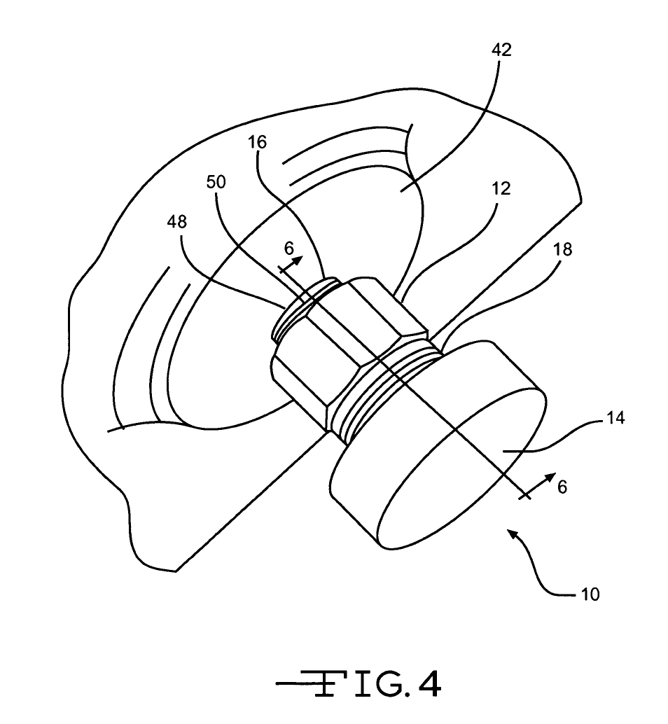

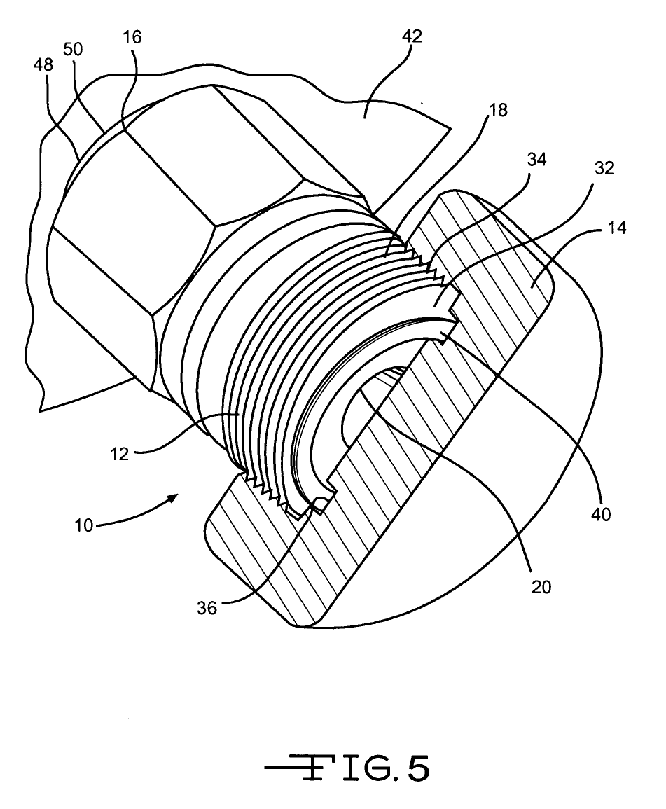

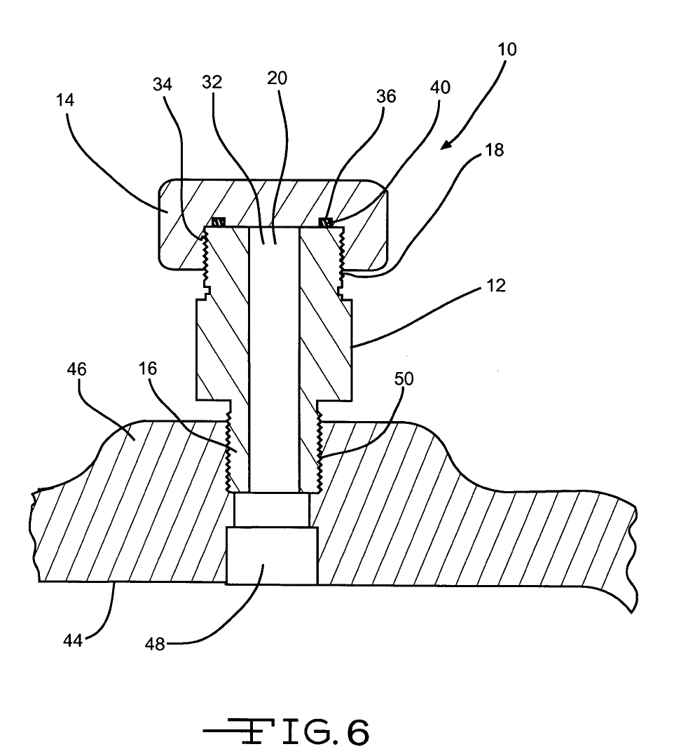

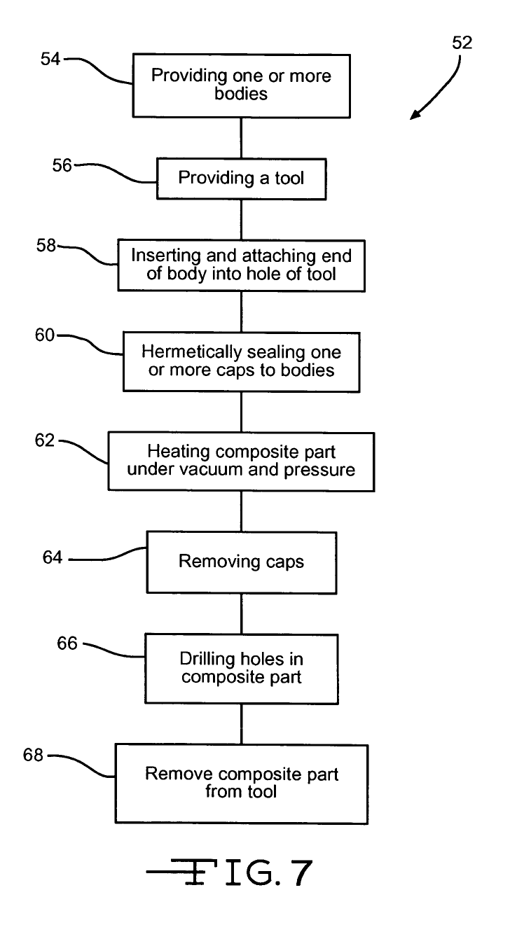

FIG. 4-6 depict various views of the apparatus 10 of FIG. 1 attached to a tool 42. For instance, FIG. 4 depicts a partial perspective view of the apparatus 10 of FIG. 1 attached to the tool 42 with the cap 14 hermetically sealed to the second end 18 of the body 12. FIG. 5 depicts a partial cut-away view of FIG. 4 showing the cap 14 partially cut-away to show the attachment of the cap 14 to the second end 18 of the body 12. FIG. 6 depicts a partial cut-away view along line 6-6 in FIG. 4 to show a partial cross-sectional view through the tool 42 and apparatus 10.

As best shown in FIGS. 6, the tool 42 may comprise a first top-surface 44 adapted to abut against and define the shape of a composite being formed by the tool 42, a second opposing surface 46 on the back-opposite side of the tool 42, and a hole 48 extending from the first top-surface 44 to the second opposing surface 46 through a cross-section of the tool 42. The hole 48 may be defined by a threaded interior surface 50 which may extend through only a portion of the hole 48, or which may extend through the entire hole 48. The hole 48 may be in a variety of shapes, sizes, orientations, and configurations. During a curing process, a composite may be cured while disposed over the first-top surface 44 of the tool 42 in order to manufacture the composite in the shape of the first-top surface 44. In such manner, a part may be manufactured in the desired shape. The second opposing surface 46 may not come in contact with the composite being cured, and as a result, may not be as critical of a surface as the first-top surface 44 over which the composite may be directly cured.

As depicted in FIGS. 4-6, the cap 14 may be hermetically sealed to the body 12 by screwing the threaded interior surface 34 of the hole 32 of the cap 14 onto the threaded second end 18 of the body 12. The O-ring seal 40 within the groove 36 of the cap 14 may aid in hermetically sealing the cap 14 to the body 12. In such manner, contaminants may be substantially prevented from entering the bore 20 through the second end 18 of the body 12. The threaded first end 16 of the body 12 may be screwed into the threaded portion 50 of the hole 48 of the tool 42 in order to attach the body 12 to the tool 42. In other embodiments, differing mechanisms may be utilized to attach the first end 16 of the body 12 to the hole 48.

FIG. 7 depicts one embodiment 52 of a method under the invention for preparing a composite to have one or more holes drilled in the composite. In step 54, one or more bodies may be provided. The one or more bodies may each comprise first and second ends and may each define a bore. In step 56, a tool may be provided. The tool may comprise a first surface adapted to define a shape of the composite, a second opposing surface, at least one hole, and an interior surface of the at least one hole. In step 58, the first end of at least one body may be inserted into and attached to at least one hole of the tool while at least a portion of the body, such as a ledge, is disposed over and/or abutted against the second opposing surface of the tool. This may be accomplished by screwing threads of the first end of the body into threads of the hole. In other embodiments, varying attachment mechanisms such as snap-fits may be utilized.

In step 60, one or more caps may be hermetically sealed to the second ends of the bodies. This may be achieved by utilizing one or more O-rings and/or threaded attachments. In step 62, a composite part may be layed up against the first surface of the tool, the tool may be vacuum bagged, and the composite part may be heated under vacuum and pressure. In step 64, the one or more caps may be removed providing access to the composite part from the second opposing surface of the tool. At this time, clamping may be applied to hold the composite part in place against the tool. In step 66, one or more holes in the composite part may be drilled by inserting and utilizing a drill bit through the bores running from the second ends of the bodies through the first ends of the bodies, and extending the drill bit through the holes in the tool against the composite part. If desired, to aid in guiding the drill bit, one or more drill bushings may be utilized in a portion of the holes of the tool, or one or more drill bushings may be inserted into the bodies. Conversely, if bushings are not utilized, hardened bodies may be utilized. In step 68, the composite part may be removed from the tool after all the holes in the composite part have been drilled. The one or more caps may then be replaced against the second ends of the bodies and the tool may be used to manufacture additional composite parts.

The present invention may aid in locating and/or drilling holes in a composite part, may reduce cost, may improve accuracy, may improve efficiency, may reduce required equipment, may increase repeatability, may reduce time of manufacture, and/or may reduce breakdown in equipment. In such manner, the present invention may aid in manufacturing composite parts in both airplane and non-airplane applications.

It should be understood, of course, that the foregoing relates to exemplary embodiments of the invention and that modifications may be made without departing from the spirit and scope of the invention as set forth in the following claims.

We claim:

1. An apparatus to aide in drilling holes in a composite comprising:
a body defining a bore, said body comprising first and second ends, wherein said first end of said body is adapted to be secured to an interior surface of a hole defined in a tool for forming said composite; and
a cap which is adapted to be hermetically sealed to said second end of said body.

2. The apparatus of claim 1 wherein said body is made of steel.

3. The apparatus of claim 1 wherein said first end of said body is threaded, and said first end of said body is adapted to be screwed into a threaded interior surface of a hole defined in a tool for forming said composite.

4. The apparatus of claim 1 wherein at least a portion of said body is adapted to be disposed over an opposing surface of a tool for forming said composite, wherein said opposing surface opposes a first surface of said tool which is adapted to abut against the composite.

5. The apparatus of claim 1 wherein said body further comprises a ledge which is substantially perpendicular to said first end of said body.

6. The apparatus of claim 5 wherein said ledge is adapted to be disposed over at least a portion of an opposing surface of a tool for forming said composite, wherein said opposing surface opposes a first surface of said tool which is adapted to abut against the composite.

7. The apparatus of claim 1 wherein said cap is made of steel.

8. The apparatus of claim 1 wherein said cap is adapted to be threadedly attached to said second end of said body.

9. The apparatus of claim 1 wherein the cap further comprises an o-ring.

10. The apparatus of claim 1 further comprising a tool defining at least one hole, wherein said tool comprises a first surface which is adapted to abut against the composite, a second opposing surface, and an interior surface of said at least one hole.

11. The apparatus of claim 10 wherein at least a portion of said body is adapted to be disposed over said second opposing surface of said tool when said first end of said body is inserted into and secured within said interior surface of said at least one hole.

12. An apparatus to aide in drilling holes in a composite comprising:
a body defining a bore, said body comprising first and second ends;
a tool defining at least one hole, said tool comprising a first surface which is adapted to abut against the composite, a second opposing surface, and an interior surface of said at least one hole;
wherein said first end of said body is adapted to be inserted into and secured within said interior surface of said at least one hole while another portion of said body is disposed over the second opposing surface of the tool.

13. The apparatus of claim 12 wherein said body is made of steel.

14. The apparatus of claim 12 wherein said first end of said body is threaded, said interior surface of said at least one hole is threaded, and said first end of said body is adapted to be screwed into said threaded interior surface of said at least one hole.

15. The apparatus of claim 12 wherein said body further comprises a ledge which is substantially perpendicular to said first end of said body.

16. The apparatus of claim 15 wherein said ledge is adapted to be disposed over said second opposing surface of said tool.

17. The apparatus of claim 12 further comprising a cap which is adapted to be hermetically sealed to said second end of said body.

18. The apparatus of claim 17 wherein said cap is made of steel.

19. The apparatus of claim 17 wherein said cap is adapted to be threadedly attached to said second end of said body.

20. The apparatus of claim 17 wherein the cap further comprises an o-ring.

21. A method for preparing a composite to have one or more holes drilled in the composite, the method comprising the steps of:
providing a body defining a bore, the body comprising first and second ends;
providing a tool defining at least one hole, the tool comprising a first surface adapted to define a shape of the composite, a second opposing surface, and an interior surface of said at least one hole; and
inserting the first end of said body into said at least one hole while at least a portion of said body is disposed over the second opposing surface of said tool.

22. The method of claim 21 wherein the step of inserting the first end of said body into said at least one hole comprises threadedly attaching the first end of said body to the interior surface of said at least one hole.

23. The method of claim 21 wherein the provided body further comprises a ledge, and the step of at least a portion of the body being disposed over the second opposing surface of said tool comprises the ledge being disposed over the second opposing surface of said tool.

24. The method of claim 21 further comprising the step of providing a cap.

25. The method of claim 24 further comprising the step of hermetically sealing the cap to the second end of said body.

26. The method of claim 25 wherein the step of hermetically sealing the cap to the second end of said body comprises locating an o-ring in said cap and threadedly attaching said cap to said second end of said body.

27. The method of claim 25 further comprising the step of heating the composite while the cap is hermetically sealed to the second end of said body.

28. The method of claim 27 further comprising the step of removing the cap from the second end of said body after the composite is heated.

29. The method of claim 28 further comprising the step of inserting a drill bit through said bore and through said at least one hole of said tool.

30. The method of claim 29 further comprising the step of drilling a hole in the composite using said drill bit.
